(19) United States
(12) Patent Application Publication
(10) Pub. No.: US 2018/0141243 A1
(43) Pub. Date: May 24, 2018

(54) POST-CURING METHOD AND STEREOLITHOGRAPHY METHOD

(71) Applicant: Roland DG Corporation, Hamamatsu-shi (JP)

(72) Inventors: Ryusuke MOCHIZUKI, Hamamatsu-shi (JP); Akira HARADA, Hamamatsu-shi (JP)

(21) Appl. No.: 15/817,833

(22) Filed: Nov. 20, 2017

(30) Foreign Application Priority Data
Nov. 21, 2016 (JP) 2016-226000

(51) Int. Cl. B29C 35/08; B29C 64/135; B33Y 10/00; B33Y 40/00

(52) U.S. Cl. CPC B29C 35/0805; B29C 64/135; B29C 2035/0827; B33Y 40/00; B33Y 10/00

(57) ABSTRACT

A method of post-curing a modeled object in a green state based on modeling data generated according to a working model includes a curing step of exposing the modeled object to light while the modeled object is fitted to the working model to secondary-cure the modeled object.

### CROSS REFERENCE TO RELATED APPLICATIONS

This application claims the benefit of priority to Japanese Patent Application No. 2016-226000 filed on Nov. 21, 2016. The entire contents of this application are hereby incorporated herein by reference.

### BACKGROUND OF THE INVENTION

### 1. Field of the Invention

The present invention relates to post-curing methods and stereolithography methods.

### 2. Description of the Related Art

3D printers can create 3D modeled objects by layering a resin based on 3D modeling data designed beforehand using a computer. Specific methods of creating 3D modeled objects include a stereolithography method for creating a modeled object by exposing a liquid photosensitive resin to light (e.g., ultraviolet light) to cure the resin bit by bit.

Some modeled objects created using the stereolithography method are in a state where the photosensitive resin is not fully cured (which may also be referred to as a “green state” hereinafter). Although having intended shapes, such modeled objects in the green state are likely to be deformed and do not have enough strength. Therefore, such modeled objects cannot be practically used.

The modeled objects in the green state should be subjected to post-curing (secondary-curing) treatment. Post-curing is a treatment for exposing a modeled object in the green state to light (e.g., ultraviolet light) to fully cure the modeled object (see, for example, JP-A-2002-347124 and “Learn more about stereolithography,” by JMC Corporation, available online at <URL: https://www.3d-printout.com/study3d/study_sla2/>, retrieved on Nov. 7, 2016).

When a modeled object in a green state is exposed to light, the photosensitive resin contracts and the post-cured modeled object is thus deformed or warped. That is, the post-cured modeled object becomes different from the modeling data, reducing the accuracy of model creation. Such reduction in accuracy significantly affects modeled objects that require high accuracy such as dental restorations (e.g., prostheses and dentures).

### SUMMARY OF THE INVENTION

Preferred embodiments of the present invention provide post-curing methods and stereolithography methods with which modeled object with high accuracy can be obtained.

According to a preferred embodiment of the present invention, a method of post-curing a modeled object in a green state based on modeling data generated according to a working model includes a curing step of exposing the modeled object to light while the modeled object is fitted to the working model to secondary-cure the modeled object.

According to preferred embodiments of the present invention, modeled objects with high accuracy are obtained.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram showing a working model according to a preferred embodiment of the present invention.

FIG. 2 is a flow diagram of a stereolithography method according to a preferred embodiment of the present invention.

FIG. 3 is a diagram showing a modeled object according to a preferred embodiment of the present invention.

FIG. 4 is a diagram showing a working model and a modeled object according to a preferred embodiment of the present invention.

### DETAILED DESCRIPTION OF THE PREFERRED EMBODIMENTS

Various preferred embodiments of the present invention will be described with reference to the drawings.

That is, post-curing methods wherein a modeled object is secured to a working model using a fixing member after the modeled object is fitted to the working model will be described. Such post-curing methods allow secondary curing while correcting deformation and/or warp of a modeled object in a green state.

In addition, post-curing methods wherein the fixing member is transparent to light will be shown. By using a material transparent to light, a portion where the fixing member is used can also be subjected to the secondary-curing.

Further, post-curing methods wherein the curing step includes a first curing step of exposing the modeled object to light with the modeled object fitted to the working model; and a second curing step of removing, after the first curing step, the modeled object from the working model and exposing, to light, a portion of the modeled object that has not been directly exposed to light in the first curing step, will be described. Such post-curing methods more fully cure the modeled object.

Moreover, stereolithography methods including a first modeling step of exposing a photosensitive resin material to light based on modeling data generated according to a working model to create a modeled object in a green state; and a second modeling step of exposing the modeled object to light with the modeled object fitted to the working model to allow the modeled object to be secondary-cured will be described. With such stereolithography methods, modeled objects with high accuracy are obtained.

Photosensitive resin material is a material that is cured by light of certain wavelengths. Typical photosensitive resin material is in a liquid state at room temperature. As the resin material, for example, an ultraviolet curable resin which is cured by ultraviolet light can be used. The ultraviolet curable resin is, for example, PRH35-ST (acrylic resin manufactured by Roland DG Corporation).

Stereolithography apparatuses create target modeled objects by exposing a resin material to light to cure the material based on modeling data representing the shape of an object to be molded. Stereolithography apparatuses according to preferred embodiments of the present invention are not particularly limited as long as the apparatuses can create modeled objects in a green state. For example, a known stereolithography machine (ARM-10 manufactured by Roland DG Corporation) can be used. The intensity and duration of radiation can be appropriately adjusted to the structure of the modeled object, required accuracy, and the like.

A post-curing apparatus exposes a modeled object in the green state to light to fully cure the modeled object. Post-curing apparatuses according to preferred embodiments of the present preferred embodiment are not particularly limited as long as the apparatuses can fully cure the modeled object in the green state. For example, a post-curing apparatus preferably includes a work table on which the modeled object is placed in the apparatus, and exposes the modeled object placed on the work table to light from all directions. Furthermore, the post-curing apparatus may switch between short-wavelength light to cure the surface of the modeled object and long-wavelength light to cure the interior of the modeled object.

Post-curing (secondary-curing) is typically performed for a longer time under an environment of a higher temperature than in pre-curing (stereolithography) in a stereolithography machine. Specific conditions (the intensity and duration of radiation, for example) can, however, be appropriately adjusted to the structure of the modeled object, required accuracy, and the like, as with the case of the stereolithography machine.

The stereolithography machine and the post-curing apparatus may have different configurations or may be integrated in a single machine. The post-curing treatment may be performed without a dedicated post-curing apparatus. For example, secondary curing may be promoted by exposing the molded object in the green state to the sunlight.

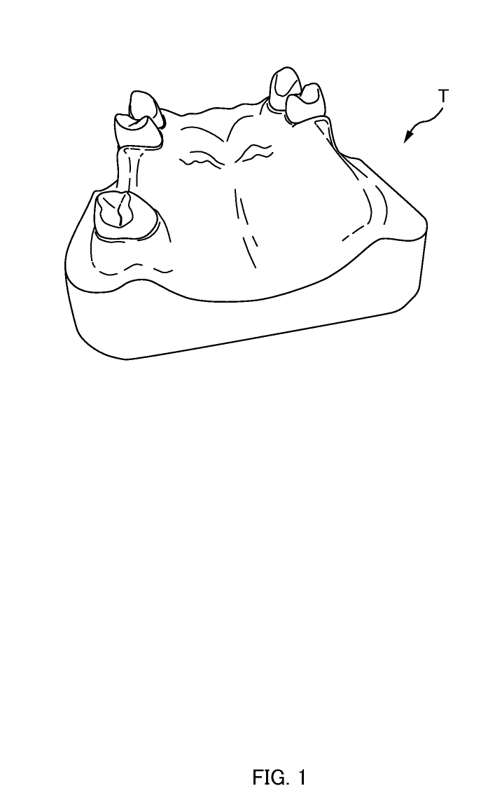

A working model is a model used as a reference for an operator to create a modeled object. The working model according to this preferred embodiment is used, for example, to create modeling data or for stereolithography methods (details of which are described later). Hereinafter, abutment teeth T are described as an example of the working model. FIG. 1 is a perspective view of the abutment teeth T.

The abutment teeth T are used when a dental technician creates a dental prosthesis. The abutment teeth T are created, for example, in the following procedure.

First, an impression of tissues in the mouth of a patient who uses a dental prosthesis is taken. The impression is an imprint or a negative replica of the tissues in the mouth of the patient. The impression can be made using a conventional method. Specifically, a custom tray (i.e., a tray for an individual patient) loaded with an impression material is fitted in the oral cavity of the patient to make the impression. The impression material used is, for example, silicone. To take the impression, a border molding technique is used as an example.

Next, dedicated plaster is poured into the impression that has been made, and is set in therein. The shape of the set plaster is then adjusted to complete the abutment teeth T (see, FIG. 1). The material used for the abutment teeth T is not limited to plaster. It is, however, preferable that the abutment teeth T are made of a less deformable material because it is used for modeling data generation and stereolithography.

The modeling data represents a shape of a modeled object. In this preferred embodiment, the modeling data is generated according to the abutment teeth T.

Specifically, the abutment teeth T are subjected to 3D scanning using a scanner device to obtain 3D data of the abutment teeth T.

Next, using a 3D CAD system or the like, the shape of a target modeled object is created on the 3D data of the abutment teeth T. As described above, the abutment teeth T are reproductions of shapes in the oral cavity of the patient who uses a dental prosthesis. Accordingly, by creating the shape of the modeled object so as to fit the abutment teeth T, modeled object data (modeling data) suitable for a patient is obtained. In this way, the abutment teeth T (the 3D data of the abutment teeth T) are objects which the modeled object is based on.

The modeling data may include, in addition to the shape of the modeled object, control information for a stereolithography machine and/or a post-curing apparatus, and irradiation conditions (e.g., the intensity and duration of radiation).

A stereolithography method according to this preferred embodiment includes a first modeling step and a second modeling step. In the first modeling step, based on the modeling data generated according to the working model, the photosensitive resin material is exposed to light to create a modeled object in the green state. In the second modeling step, the modeled object is exposed to light with the modeled object fitted to the working model to allow it to be secondary-cured. The second modeling step (curing step) corresponds to the post-curing method according to this preferred embodiment.

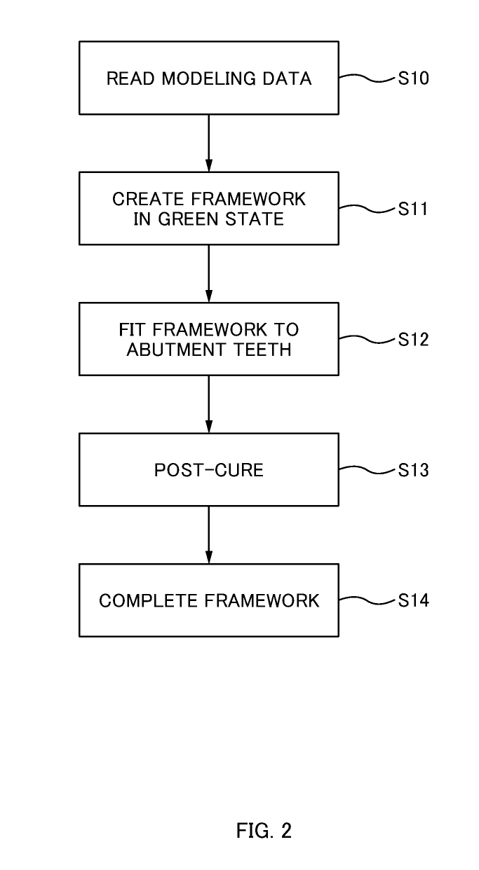

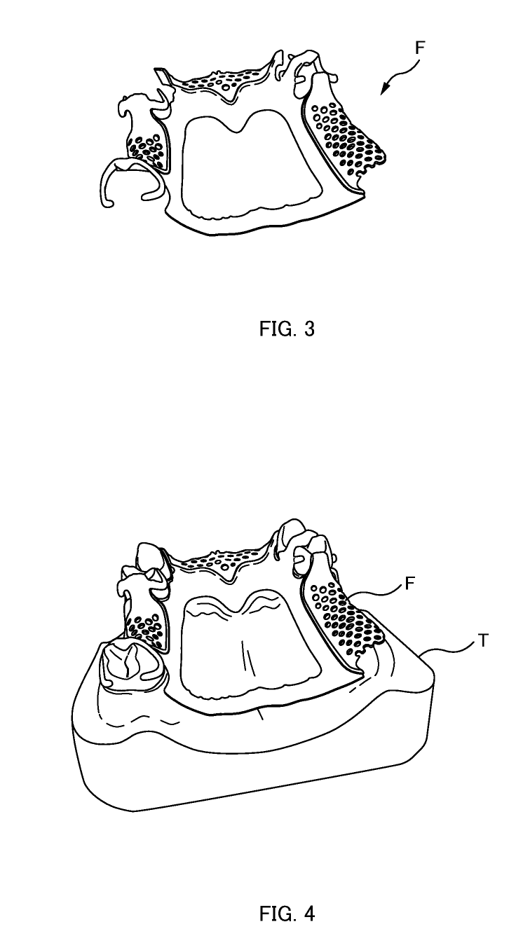

Referring to FIGS. 2 to 4, details of the stereolithography method according to this preferred embodiment are described in terms of a specific example. In this example, creation of a framework F is described. The framework F is a part used in creating a metal frame (an example of dental restoration) for a tooth bridge used for a partial denture. FIG. 2 is a flow diagram of a stereolithography method. FIG. 3 is a perspective view of the framework F. FIG. 4 is a perspective view showing the framework F fitted to the abutment teeth T. The modeling data for the abutment teeth T and the framework F are assumed to be generated beforehand.

First, the stereolithography machine reads the modeling data generated by a 3D CAD system (read modeling data at S10).

The stereolithography machine exposes a resin material to light based on the modeling data read at S10 to create the framework F in the green state (create framework in green state at S11). S11 is an example of the “first modeling step.”

Next, the framework F obtained at S11 is fitted to the abutment teeth T (fit framework to abutment teeth at S12; see FIG. 4). By fitting the framework F to the abutment teeth T, the shape of the framework F is able to be corrected even when the framework F created by the stereolithography machine and the modeling data do not match.

Then, the abutment teeth T and the framework F are placed in the post-curing apparatus to perform post-curing treatment. That is, the post-curing apparatus exposes the framework F combined with the abutment teeth T to light to allow the framework F in the green state to be secondary-cured (post-cure at S13). As a result, a fully cured framework F is able to be obtained (complete framework at S14). S13 is an example of the “second modeling step.”

A metal frame for a tooth bridge is able to be obtained by making a mold based on the completed framework F, pouring a metal into the mold, and solidifying the metal therein.

The framework F completed at S14 may be subjected to a post-treatment such as washing as in the case of modeled objects created in a typical stereolithography machine.

As described above, in the stereolithography method and the post-curing method according to this preferred embodiment, the shape of the modeled object in the green state is able to be corrected by fitting the modeled object to the working model. The subsequent post-curing treatment performed in this state makes it possible to prevent deformation and/or warp which otherwise would occur during post-curing, while adjusting deformation caused during the creation. Accordingly, the modeled object that has been subjected to the post-curing will be the one with high accuracy suitable to the modeling data.

Further, the stereolithography method and the post-curing method according to this preferred embodiment is able to be performed using a conventional apparatus/machine, which eliminates the necessity of purchasing a new one. If the modeled object at the creating (pre-curing) stage in the stereolithography machine does not have enough accuracy, the accuracy is improved by the post-cure treatment. Therefore, it is unnecessary to use a stereolithography machine having a higher performance. The stereolithography method and the post-curing method according to this preferred embodiment are thus simple and are able to be performed at a lower cost.

For example, in the example shown in FIG. 4, when the abutment teeth T are made of a material such as a plaster that is not transparent to light, the backside (the surface contacting the abutment teeth T) of the framework F is not exposed to light during the post-cure treatment. This means that the backside of the framework F is able to remain in the green state.

Accordingly, it is possible to divide the second modeling step (curing step) into two stages. Specifically, as a first curing step, the modeled object in the green state is exposed to light with the modeled object fitted to the working model. Then, as a second curing step, the modeled object is removed from the working model and a portion of the modeled object that has not been directly exposed to light in the first curing step is exposed to light. At least more than half of the modeled object has been completely cured after the first curing step, so that the modeled object is less likely affected by deformation or warp even after being removed from the working model. Such a method ensures complete curing of the entire modeled object more reliably. The intensity and duration of radiation is able to be varied between the first and second curing steps. For example, the modeled object has been cured almost completely during the first curing step. The intensity and/or duration of radiation is able to be reduced in the second curing step as compared to the first curing step.

Further, in the example in FIG. 4, if the framework F and the modeling data do not match, the framework F is able to be separated from the abutment teeth T at the time of fitting. When the secondary curing is performed without fitting the framework F to the abutment teeth T as above, the accuracy of the modeled object obtained after the post-curing may be deteriorated. It is thus preferable to fix the framework F in the green state to the abutment teeth T by using a fixing member after the framework F is fitted to the abutment teeth T. In addition, the fixing member used at this time is preferably a member that transmits the light used in the post-curing treatment. Specifically, a UV transparent tape material (typical Cellophane tape (registered trademark)) can be used.

In the above preferred embodiments, an example of creating the framework F has been described, but the modeled object is not particularly limited as long as something equivalent to the working model is able to be obtained. For example, the modeled object may be a denture base (a base to which wax corresponding to the gingiva is attached) used for complete dentures. Alternatively, the post-curing method is able to be applied not only to dental restorations but other objects such as artificial nail enhancements placed over nails (in this case the nails themselves serve as working models).

The foregoing preferred embodiments and examples have been provided as examples of the present invention and are not intended to limit the scope of the invention. The above configurations can be implemented in appropriate combinations, and various omissions, replacements, and changes can be made without departing from the scope of the present invention. The above preferred embodiments and modifications thereof are included in the scope and spirit of the present invention as well as within the invention described in the claims and their equivalents.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method of post-curing a modeled object in a green state based on modeling data generated according to a working model, comprising:
a curing step of exposing the modeled object to light while the modeled object is fitted to the working model to secondary-cure the modeled object.

2. The method according to claim 1, wherein the modeled object is secured to the working model using a fixing member after the modeled object is fitted to the working model.

3. The method according to claim 2, wherein the fixing member is transparent to light.

4. The method according to claim 1, wherein the curing step comprises:
a first curing step of exposing the modeled object to light while the modeled object is fitted to the working model; and
a second curing step of removing, after the first curing step, the modeled object from the working model and exposing to light a portion of the modeled object that has not been directly exposed to light in the first curing step.

5. A stereolithography method comprising:
a first modeling step of exposing a photosensitive resin material to light based on modeling data generated according to a working model to create a modeled object in a green state; and
a second modeling step of exposing the modeled object to light while the modeled object is fitted to the working model to secondary-cure the modeled object.
